(19) United States
(12) Patent Application Publication
(10) Pub. No.: US 2015/0134953 A1
(43) Pub. Date: May 14, 2015

(54) METHOD AND APPARATUS FOR OFFERING CLOUD-BASED HSM SERVICES

(71) Applicant: MOTOROLA SOLUTIONS, INC, SCHAUMBURG, IL (US)

(72) Inventors: MARK D. SEABORN, ALGONQUIN, IL (US); ANTHONY R. METKE, NAPERVILLE, IL (US)

(73) Assignee: MOTOROLA SOLUTIONS, INC, SCHAUMBURG, IL (US)

(21) Appl. No.: 14/075,624

(22) Filed: Nov. 8, 2013

(51) Int. Cl. H04L 29/06; H04L 9/08

(52) U.S. Cl. CPC H04L 63/08; H04L 9/0861
USPC 713/168

(57) ABSTRACT

A HSM service controller receives an administrative request to enable a cloud-based application to have access to a cloud-based HSM service. The HSM service controller segments a cloud-based HSM into a plurality of VHSMs. The HSM service controller allocates to the cloud-based application, a source VHSM from among the plurality of VHSMs. The source VHSM includes an initial set of credentials, roles and/or metadata. The HSM service controller stores a handle for the source VHSM in association with a handle for the cloud-based application. The HSM service controller routes cryptography requests between the cloud-based application and the VHSM based on the handle for the source VHSM and the handle for the cloud-based application. The HSM service controller receives one or more management requests from the cloud-based application and executes cloud administrator functions responsive to the management request.

### BACKGROUND OF THE INVENTION

Cloud computing relies on sharing of resources over a computer network and uses economies of scale to reduce computing costs. For example, customers, such as banks, credit card processing companies, or retail stores may execute applications on a computer network provided by a cloud provider. The cloud resources may be dynamically assigned to customers based on each customer's usage patterns, where the cloud resources assigned to a customer may be dynamically increased or decreased in accordance with the customer's usage patterns. Cloud providers typically offer mechanisms to segregate resources assigned to customers, thus creating a multi-tenant environment. However, customers with highly sensitive information may require strict data access policies to ensure privacy of the highly sensitive information. Accordingly, to process secure cloud transactions a bank or a credit card processing company, for example, would need to protect resources, such as private keys that matched public keys and certificates used for secure socket layer connections to the bank's or credit card processing company's website.

A cloud provider that is hosting protected resources, such as the private keys, needs to secure that data in a way that assures the owner of a protected resource that only the owner is in control of the protected resource. In a non-cloud environment, protected resources may be stored in a certified Hardware Encryption Module (HSM). A HSM is a computing device that safeguards and manages digital authentication keys and provides crypto-processing without revealing decrypted data. The HSM may be attached directly to a server or general purpose computer through a network or universal serial bus (USB) connection. However, HSMs do not normally operate in high demand environments and typically process about 60 crypto-operations per second. Using the example where a credit card processing company's website is hosted by a cloud provider, the website may process thousands of financial transactions per second on a typical day. In addition, the credit card processing company's website may have to process significantly more transactions during specific periods, for example, on Black Fridays. While such a website may be appropriate for cloud computing because of the economy of scale offered by sharing cloud resources, there is a need for the owner of the website to access HSM services in a manner that is proportional to the usage of the cloud resources and in a manner that allows the owner to protect resources from the other cloud customers and from the cloud provider.

Accordingly, there is a need for a method and apparatus for offering cloud-based HSM services.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system configured to offer cloud-based hardware encryption module (HSM) services in accordance with some embodiments.

FIG. 2 is a block diagram that depicts how a HSM service controller assigns a virtual HSM (VHSM) in accordance with some embodiments.

FIGS. 3A and 3B are block diagrams of VHSM copy results in accordance with some embodiments.

FIG. 4 is a flow diagram of a method for offering cloud-based HSM services in accordance with some embodiments.

FIG. 5 is a block diagram of a HSM service controller used in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to methods and apparatuses for offering cloud-based hardware encryption module (HSM) services. A HSM service controller receives an administrative request to enable a cloud-based application to have access to a cloud-based HSM service. The HSM service controller segments a cloud-based HSM into a plurality of VHSMs. The HSM service controller allocates to the cloud-based application, a source VHSM from among the plurality of VHSMs. The source VHSM includes an initial set of credentials, roles and/or metadata. The HSM service controller stores a handle for the source VHSM in association with a handle for the cloud-based application. The HSM service controller routes cryptography requests between the cloud-based application and the VHSM based on the handle for the source VHSM and the handle for the cloud-based application. The HSM service controller receives one or more management requests from the cloud-based application and executes cloud administrator functions responsive to the management request.

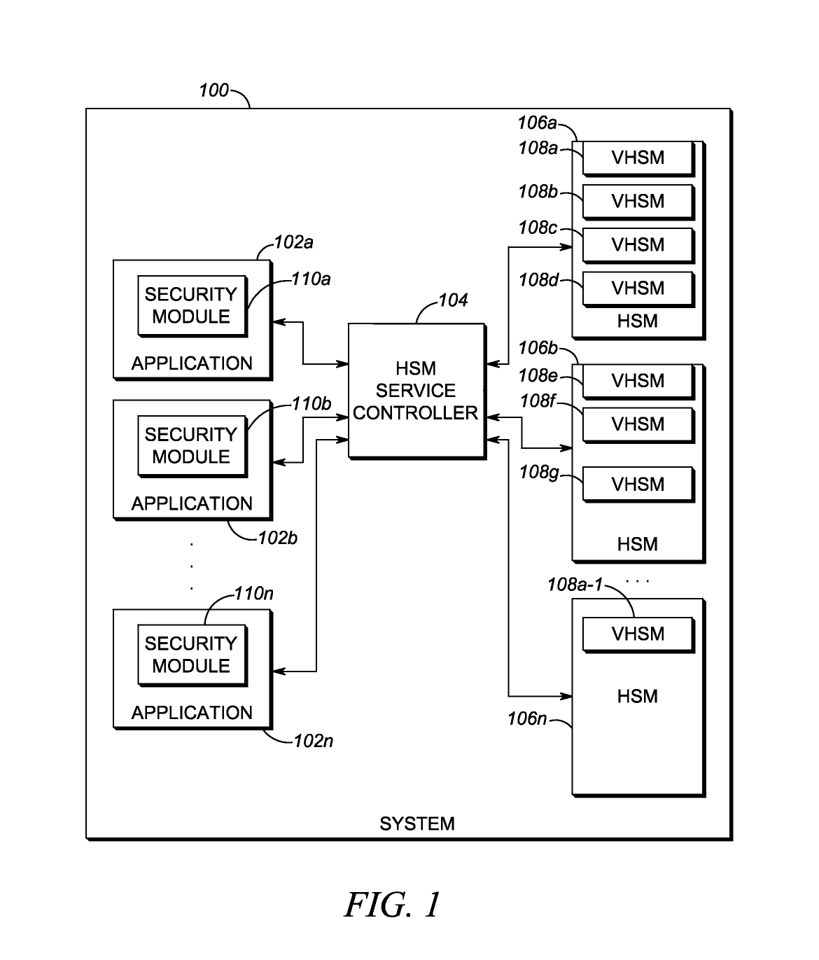

FIG. 1 is a block diagram of a system 100 configured to offer cloud-based hardware encryption module (HSM) services in accordance with some embodiments. System 100 includes services or applications 102 (i.e., applications 102a-102n) that may be executed in a cloud computing environment. Applications 102 may be, for example, web-sites or other applications owned by customers of a cloud provider. Applications 102 may access protected resources, such a private keys owned by the customers of the cloud provider. Application(s) 102 may include or be communicatively coupled to application security modules 110 (i.e., application security modules 110a-110n) that may be configured to create and/or manage the protected resources used by applications 102.

System 100 also includes cloud-based HSMs 106 (i.e., HSM 106a-106n) offered by the cloud provider to provide certified crypto services. HSMs 106 may be installed in a data center and offered by the cloud provider as Trusted Cloud Assets (TCA) to cloud customers. A TCA as used here may refer to a device or a process on a device that stores or uses cryptographic materials that is to be protected from unauthorized disclosure or use. An example of a TCA may be an HSM or a Virtual HSM. Cloud-based HSM functions may be authenticated to ensure that an application 102 requiring access to the TCA is actually communicating with the intended HSM 106. For example, HSM manufacturers may provide an identity key/certificate on each HSM 106 that can be accessed by applications 102 to ensure that an application requiring access to the TCA is actually communicating with the intended HSM 106. The HSM manufacturers may also include the name of the cloud provider as a part of information that is digitally signed by the manufacturer or cloud provider and placed on a HSM card.

Each HSM 106 is a device that includes one or more of computation capabilities and storage capabilities, for example, for accounts and access control rules. A typical HSM 106 may include one administrator account which may be used to create, delete, and manage one or more user accounts. A user account, protected by a user password, may be used to access data created on or transferred to a HSM 106 by the user (i.e., the customers of the cloud provider). Typically, user data may include cryptographic secrets such as a protected key. HSM 106 may enforce access control rules for the data associated with each user account. An example of an access control rule that may be enforced by HSM 106 is one that specifies that only a user that created data may access that data via the user account. Another example of an access control rule that may be enforced by HSM 106 is a discretionary access control rule that specifies that a user is allowed to specify which other user accounts may access data created by the user.

An administrator account may or may not have access to user account data, including the key and passwords associated with the user accounts. In an embodiment, multiple segments called Virtual HSMs (VHSMs) 108 (i.e., VHSMs 108a-108g and 108a−1) are created from one HSM 106 (e.g., VHSMs 108a-108d with respect to HSM 106a, VHSMs 108e-108g with respect to HSM 106b, and VHSM 108a−1 with respect to HSM 106n), where each segment may be administered by a separate administrator account. A cloud administrator account may allocate HSM resources such as storage to an administrator account. The resources allocated to an administrator account and the corresponding access control rules for that account are referred to as a segment or partition of the HSM, or as a VHSM 108.

A HSM service controller 104 is configured to execute functions (referred to herein as the cloud administrator functions) designed to manage VHSMs 108. The functions executed by HSM service controller 104 may include VHSM copying, VHSM deleting, mapping of VHSMs 108 to applications 102, and assuring that only authorized applications can communicate with VHSMs 108. HSM service controller 104 may secure the cloud administrator functions with authentication credentials, such as a PIN or other credentials, owned by the cloud provider. The cloud administrator function PIN may be set when the HSMs 106 are installed in system 100. Subsequent to installing and securing HSMs 106, HSM service controller 104 is configured to communicate using management application programming interfaces (APIs), for example, for creating, copying and/or deleting VHSMs 108 in HSMs 106. Customer applications 102 may access a VHSM via a PKCS #11 standard, wherein in an embodiment, the PKCS #11 standard may be extended to include new functions which allow the HSM service controller 104 to manage VHSMs 108 as locked containers. A locked container is a collection of data that can only be accessed by the owner of the data (also referred to as a resource owner) via, for example, an associated application 102. Therefore, in an embodiment where HSM service controller 104 can only manage the VHSM 108 as a locked container, HSM service controller 104 can only create VHSMs, delete VHSMs, copy encrypted VHSM data to other VHSMs owned by the same resource owner, and associate VHSMs with a resource owner (i.e., with an applications or instances of applications owned by the resource owner). For example, the VHSMs 108 may be managed in a manner analogous to the management of a bank safety deposit box, where a bank offering the safety deposit box may access the safety deposit box but cannot access the contents of the box without using a key provided by the owner of the box (i.e., the customer of the bank). System 100 therefore enables secure management of the VHSMs 108 while providing cloud features such as high availability and elasticity.

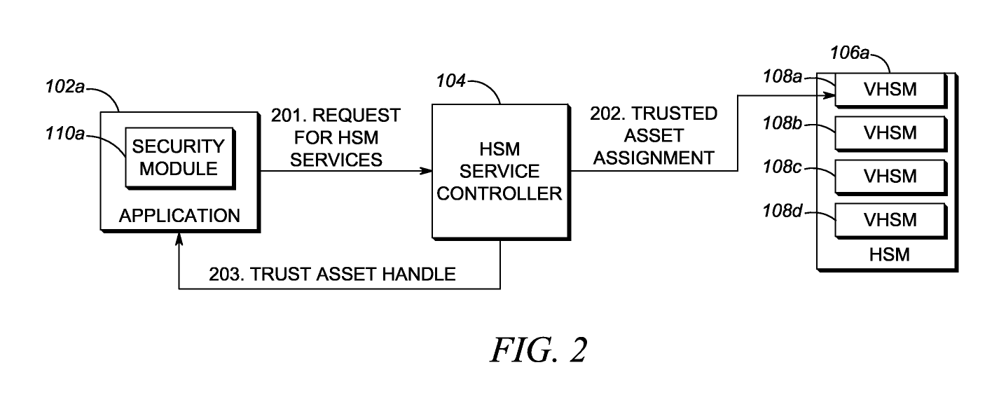

FIG. 2 is a block diagram that depicts how the HSM service controller 104 assigns a VHSM in accordance with some embodiments. After HSM service controller 104 executes cloud administrator functions to install and initialize HSMs 106, at 201, HSM service controller 104 may receive an administrative request for HSM services from a cloud customer, via an administrative console. The administrative request may include parameters associated with a protected resource to be used by an instance of application 102a, for example. The administrative request may include protected data parameters including, for example, the type of private keys (algorithm and size) to be used by an instance of application 102a, the number of each type of private keys, authorized application identity, and key activation data. In response to the administrative request for HSM services, at 202, HSM Service controller 104 may interact with, for example, HSM 106a, create, for example, VHSM 108a, assign VHSM 108a to application 102a, and maintain a mapping between applications 102 and the VHSM(s) 108 assigned to each application 102. When HSM service controller 104 allocates VHSM 108a to application 102a, VHSM 108a is configured to include at least one of an initial set of credentials, roles and other metadata that may be subsequently replaced by the cloud customer. For example, VHSM 108a may include user roles, access control rules, and secure storage. In general, only access control rules for the administrator role of the VHSM may be set by the cloud provider, wherein the access control rules set by the cloud provider may be subsequently changed by the cloud customer to secure the access control rules from the cloud provider.

At 203, HSM service controller 104 assigns a Trusted Asset Handle (TAH) to VHSM 108a, associates the TAH for VHSM 108a with a handle for application 102a, stores the association, and returns the TAH for VHSM 108a to the owner of application 102a (i.e., the cloud customer). HSM service controller 104 may send the TAH directly to application 102a or to another application, for example, application security module 110a, associated with application 102a. This assigns control of VHSM 108a that is to be used by an instance of application 102a directly to application 102a or to another application, for example, application security module 110a, associated with application 102a. The TAH is typically used for routing, and not for secure access control.

In order to secure, for example, VHSM 108a, HSM service controller 104 sets up initial authentication credentials (for example, PIN(s)) for VHSM 108a. The instance of application 102a that is associated with VHSM 108a will need the necessary credentials to establish a session with VHSM 108a. Therefore, HSM service controller 104 sends the initial authentication credentials with the TAH directly to the administrative console. In one embodiment, the administrative console may be part of the application 102. In another embodiment, the administrative console may be a separate application. Typically, the first several operations between the administrative console and HSM service controller 104 that are processed according to the PKCS #11 standards may be to establish a session and change the administrative account authentication credentials for VHSM 108a. An administrator, via the administrative console, may then provisions user accounts on VHSM 108a and provides them to the applications 102a during a provisioning step.

Subsequent to receiving the initial authentication credentials with the TAH, application 102a and/or and associated module (for example, application security module 110a) may send a customer request (using the TAH) to HSM service controller 104, requesting a new public/private key pair and certificate signing request (CSR) for certificate creation for an instance of application 102a. HSM service controller 104 uses the TAH to determine that the customer request is to be sent to VHSM 108a. Once a session is established between application 102a and VHSM 108a, application 102a may use messages executed according to the PKCS #11 standard to request that VHSM 108a generates needed key pair(s) and CSR(s), obtain associated certificate(s), load existing key pair(s), subsequently install needed certificates and/or perform other key operations.

There are certain administrative functions that may trigger the HSM service controller 104 to copy a VHSM and over write an existing VHSM. For example, resetting a PIN on a VHSM for an application will require that HSM service controller 104 replace all VHSMs for that application with a copy of the VHSM that the customer reset the PIN on. This will keep all VHSMs associated with an application synchronized. HSM service controller 104 maintains the concept of a session between a VHSM and an application to assure security procedures can be carried out. Some security procedures require multiple steps to complete. Any information needed by the application during normal execution will be sent to the application from the administrative console during a provisioning step.

In one embodiment, HSM service controller 104 may become a proxy for PKCS #11 messages exchanged between applications 102 and HSMs 106, thereby enabling HSM service controller 104 to maintain the necessary mappings between VHSMs 108 and instances of application 102. The messages exchanged between HSM service controller 104 and applications 102, from requesting the TCA up to the returning the TAH for a VHSM 108, may occur over an encrypted tunnel using, for example, the customer's credentials and a cloud provider's certificate for setup and authentication. Alternatively, HSM service controller 104 could be queried directly by application 102 or by another application, for example, application security module 110, associated with application 102, for a mapping between the application and a VHSM 108, so that the application can interact directly with the associated VHSM 108 while an instance of the application is being executed.

HSM service controller 104 may execute special functions to manage VHSMs 108 in a manner that is dynamic and redundant. The management function executed by HSM service controller 104 may require that detailed logs be kept for security auditing. For simplicity sake, in this discussion, each VHSM 108 is paired with one instance of an application, although a VHSM may be paired with more than one instance of an application When a VHSM is paired with more than one instance of an application, the owners of the paired instances of the application may map the pairings and maintain the mapping.

Scaling operations include adding additional instances of an application 102 to handle increased network traffic to the application. When, for example, application 102a needs to scale up, a management request (i.e., a type of administrative request) may be sent to increase the instances of application 102a from, for example, 10 instances to 11 instances of application 102a. When the instances of application 102a increase, a new VHSM, for example VHSM 108a−1 (also referred to as a target VHSM), may be instantiated for the new instance of application 102a (the new instance of application 102 is referred to herein as application 102a−1).

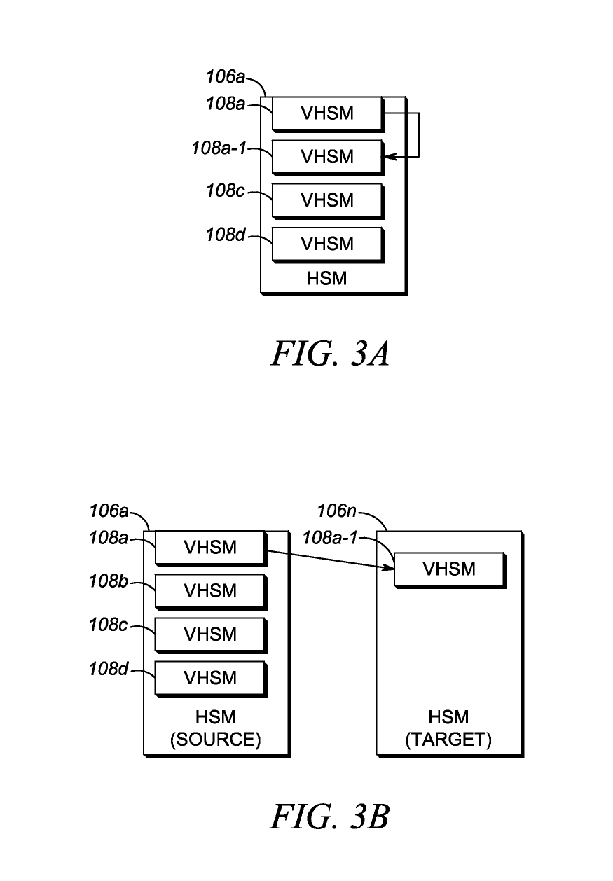

FIGS. 3A and 3B are block diagrams of VHSM copy results in accordance with some embodiments. In FIG. 3A, VHSM 108a−1 is copied on the same HSM (i.e., HSM 106a) as the source VHSM (i.e., VHSM 108a, the VHSM being copied). In FIG. 3B, VHSM 108a−1 is copied on another HSM (i.e., HSM 106n). In either case, the contents of the source VHSM (i.e., VHSM 108a), including keys and access control rules, are copied to the target VHSM (i.e., VHSM 108a−1). Therefore, HSM service controller 104 may be granted rights to copy sensitive data on a HSM 106n when VHSM 108a−1 is created for application 102a−1.

Consider the example where the duplication of source VHSM 108a requires that target VHSM 108a−1 be created on another HSM, as shown in FIG. 3B, and therefore the content of source VHSM 108a is copied from HSM 106a to HSM 106n. HSM Service Controller 104 may execute novel copy functions including, for example, a C_CopyInitialize function, a C_PrepareVHSM function, a C_InstallVHSM function used in conjunction with the PKCS#11 standards. In some embodiments, subsequent to creating target VHSM 108a−1, HSM service controller 104 may instruct target VHSM 108a−1, using the C_CopyInitialize function, to generate a temporary encryption key. The temporary encryption key generated by target VHSM 108a−1 will be used to encrypt content, including private keys, that are stored on source VHSM 108a and that will be copied in a copy operation to VHSM 108a−1. The copy operation may optionally be approved by the owner of application 102a, for example, via an associated application such as application security module 110a, before the C_CopyInitialize function is invoked by HSM service controller 104. The output of the C_CopyInitialize function is an encryption key (possibly used once) which is used to encrypt the source VHSM 108a. The encryption key can be any cryptographic key including a public key, a digital certificate containing a public key, a symmetric key, a shared secret, a password, or any other key material. In one embodiment, the encryption key generated by the C_CopyInitialize function may be signed by a private key permanently associated with the HSM, and may be further included in a certificate signed by the private key associated with the HSM or by a Certificate Authority.

At least one of an encryption key and a certificate containing the encryption key generated by target VHSM 108a−1 during the C_CopyInitialize function may be passed to source VHSM 108a by the HSM service controller 104 using the C_PrepareVHSM function. The C_PrepareVHSM function instructs the source VHSM 108a to encrypt its content, including the private key(s), access control data, and other HSM data being used by application 102a, with the encryption key of target VHSM 108a−1 (i.e., the output of the C_CopyInitialize function). The C_PrepareVHSM function returns the encrypted contents of source VHSM 108a. HSM service controller 104 may also execute a C_InstallVHSM function to install VHSM 108a−1 with the contents of VHSM 108a returned by the C_PrepareVHSM function. Using the C_InstallVHSM function, the content of source VHSM 108a is transported to target VHSM 108a−1 over a secure network link and decrypted with the private key generated by target VHSM 108a−1 or with other keying material used for the exchange as described above. After the copy operation is complete, the HSM Service Controller 104 passes the TAH for target VHSM 108a−1 to the associated instance of application 102 (i.e., application 102a−1). Each of the C_CopyInitialize, C_PrepareVHSM and C_InstallVHSM functions may be authorized by the owner of protected resources stored in HSM 106 to prevent unauthorized copying of a VHSM.

In an alternative embodiment, the contents of source VHSM 108a may not be copied. Instead, the owner of the protected resources stored on source VHSM 108a provides HSM Service Controller 104 with a number of files created according the PKCS #12 standard. Each of the files includes protected resources, for example, public/private key pair(s) and/or certificate(s). HSM service controller 104 sends the files to VHSM 108a−1. In this case, the service provider would also configure VHSM 108a−1 with the PKCS #12 decryption key in order for VHSM 108a−1 to be able to decrypt the files received from HSM service controller 104.

HSM service controller 104 may also execute a function for modifying the size of the VHSMs 108. The modifying function may require copy permissions in case a first HSM does not have enough space to accommodate a target VHSM and the target VHSM needs to be moved to a second HSM, where moving includes the same functions as copying except that the source is deleted once the contents have been moved. Typically copying from a first HSM to a second HSM is executed over a proprietary link between the HSMs, where the HSMs exchange messages to facilitate the copying of VHSM data and the messages are tunneled over a secure link between the first HSM and the second HSM.

One of the characteristic of cloud computing is built-in redundancy. For instance, multiple copies of an application 102 may be created on physically separate machines, such that when one machine fails, another machine with a copy of the application is automatically executed, and theoretically no interruption of service occurs. To ensure that owner of the application 102 is aware of how redundancy is handled by the cloud provider, the owner of the application 102 may agree to the creation and/or maintenance of redundant copies of protected resources through software license agreements (SLA). A VHSM that is to be copied (for example, VHSM 108a) is configured to support an “enable-copy” VHSM function that would prevent copying of VHSM 108a without explicit authorization by, for example, the owner of the resources stored on VHSM 108a. The authorization may be sent directly by application 102a or by an associated module, for example, security module 110a associated with application 102a. The enable-copy function is enforced at the HSM level and may not be overridden by the cloud provider through the cloud administrator functions executed in the HSM service controller 104. In one embodiment, a secure copy operation would be bootstrapped by cloud user credentials and a source VHSM (i.e., VHSM 108a) would not allow a copy to be made without verifying that the target VHSM (i.e., VHSM 108a−1) has been authorized to receive the content of VHSM 108a.

A VHSM may need to be deleted when, for example, an application 102 is terminated by either the cloud provider or a customer or when the application is scaled down. HSM service controller 104 is therefore configured to execute a C_DestroyObject function as one of the cloud administrator functions. The C_DestoryObject function is used to indicate that a VHSM object can be destroyed by a cloud administrator. The C_DestoryObject function checks an object handle (labeled, for example, as CK_OBJECT_HANDLE) in conjunction with an identity of a logged-in cloud administrator. All deletion invocations may be logged by the cloud provider and made available to the customer via, for example, the security module 110 for auditing purposes. This log should be created and stored by the HSM itself until validated by the owner of the VHSM and logged elsewhere

To accommodate the crypto libraries provided according to the PKCS standard, HSM service controller 104 may execute C_CreateObject function. The C_CreateObject function is configured to identify a class type. An existing attribute list (labeled, for example, as CK_ATTRIBUTE list) used in the PKCS standards uses a CKA_CLASS value for a VHSM. A CK_SESSION_INFO function may be modified to include a new VHSM handle, CK_VHSM_ID.

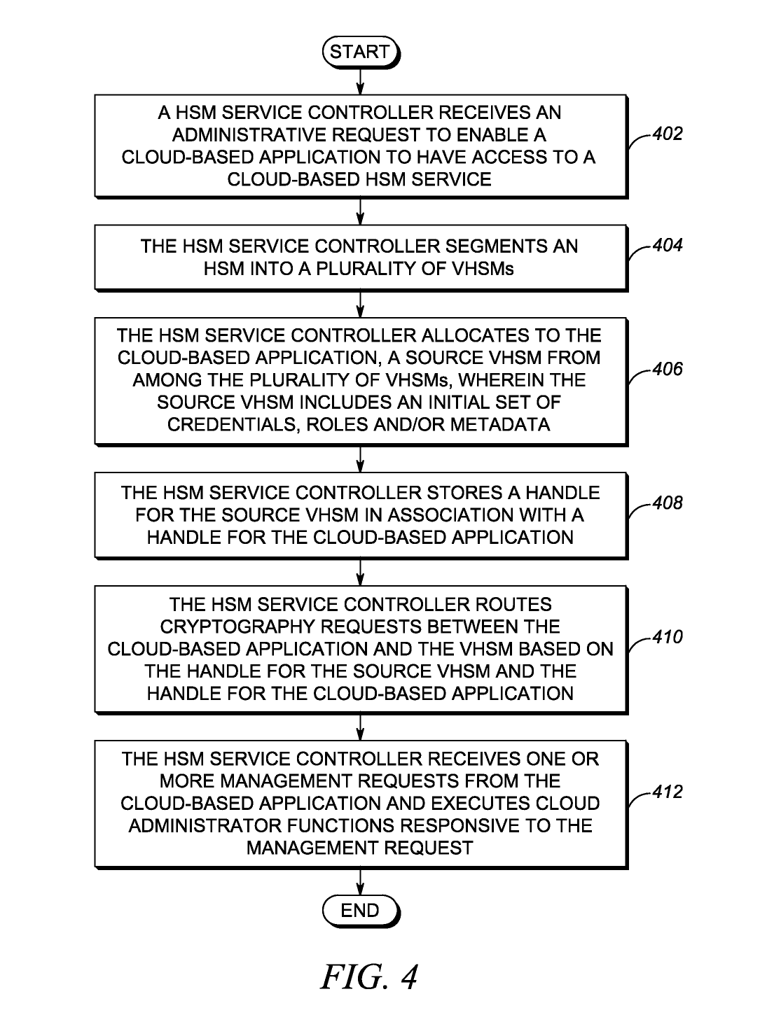

FIG. 4 is a flow diagram of a method for offering cloud-based HSM services in accordance with some embodiments. At 402, HSM service controller 104 receives an administrative request to enable a cloud-based application 102 to have access to a cloud-based HSM service. At 404, the HSM service controller segments a cloud-based HSM 106 into a plurality of VHSMs 108. At 406, the HSM service controller allocates to the cloud-based application, a source VHSM from among the plurality of VHSMs, wherein the source VHSM includes an initial set of credentials, roles and/or metadata. At 408, the HSM service controller stores a handle for the source VHSM in association with a handle for the cloud-based application. At 410, the HSM service controller routes cryptography requests between the cloud-based application and the VHSM based on the handle for the source VHSM and the handle for the cloud-based application. At 412, the HSM service controller receives one or more management requests from the cloud-based application and executes cloud administrator functions responsive to the management request.

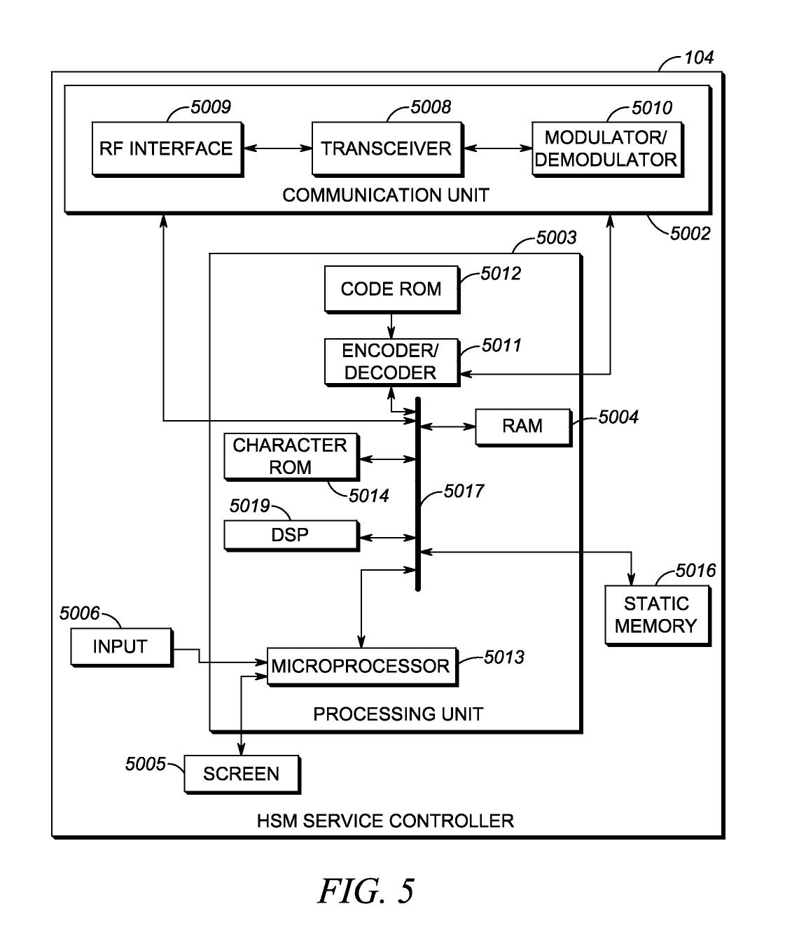

FIG. 5 is a block diagram of HSM service controller 104 in accordance with some embodiments. The HSM service controller 104 includes a communications unit 5002 coupled to a common data and address bus 5017 of a processing unit 5003. The HSM service controller 104 may also include an input unit (e.g., keypad, pointing device, etc.) 5006 and a display screen 5005, each coupled to be in communication with the processing unit 5003. The processing unit 5003 may include an encoder/decoder 5011 with an associated code ROM 5012 for storing data for encoding and decoding voice, data, control, or other signals that may be transmitted or received by the HSM service controller. The processing unit 5003 may further include one or more processors, such as a microprocessor 5013 or a Digital Signal Processor (DSP) 5019, coupled, by the common data and address bus 5017, to the encoder/decoder 5011 and one or more memory devices, such as a character ROM 5014, a RAM 5004, and a static memory 5016. The functions of HSM service controller 104 as described herein preferably are implemented with or in software programs and instructions stored in the one or more memory devices of the HSM service controller and executed by the one or more processors of the HSM service controller. However, one of ordinary skill in the art realizes that the embodiments of the present invention alternatively may be implemented in hardware, for example, integrated circuits (ICs), application specific integrated circuits (ASICs), and the like, such as ASICs implemented in the HSM service controller. Based on the present disclosure, one skilled in the art will be readily capable of producing and implementing such software and/or hardware without undo experimentation.

The communications unit 5002 may include a network interface 5009 configurable to communicate with network components (for example, the eNBs), and other user equipment (for example, subscriber units) within its communication range. The communications unit 5002 may include one or more broadband and/or narrowband transceivers 5008, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications. Additionally or alternatively, the communications unit 5002 may include one or more local area network or personal area network transceivers such as Wi-Fi transceiver perhaps operating in accordance with an IEEE 802.11 standard (e.g., 802.11a, 802.11b, 802.11g), or a Bluetooth transceiver, for subscriber device to subscriber device communications. Additionally or alternatively, the communications unit 5002 may additionally or alternatively include one or more wire-lined transceivers 5008, such as an Ethernet transceiver, a Universal Serial Bus (USB) transceiver, or similar transceiver configurable to communicate via a twisted pair wire, a coaxial cable, a fiber-optic link or a similar physical connection to a wire-lined network.

The transceivers may be coupled to a combined modulator/demodulator 5010 that is coupled to the encoder/decoder 5011. The character ROM 5014 stores code for decoding or encoding data such as control, request, or instruction messages, channel change messages, and/or data or voice messages that may be transmitted or received by the controller. Static memory 5016 may store operating code associated with processing a talk group resource requests in accordance with this disclosure, including the steps set forth in FIG. 4.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of offering cloud-based hardware encryption module (HSM) services, comprising:
receiving, by an HSM controller, an administrative request to enable a cloud-based application to have access to a cloud-based HSM service;
segmenting, by the HSM controller, a cloud-based HSM into a plurality of virtual HSMs (VHSMs);
allocating, by the HSM controller to the cloud-based application, a source VHSM from among the plurality of VHSMs, wherein the source VHSM comprises at least one of an initial set of credentials, roles and metadata;
storing, by the HSM controller, a handle for the source VHSM in association with a handle for the cloud-based application; and
routing, by the HSM controller, cryptography requests between the cloud-based application and the VHSM based on the handle for the source VHSM and the handle for the cloud-based application.

2. The method of claim 1, further comprising securing, by the HSM controller, cloud administrator functions with authentication credentials.

3. The method of claim 1, wherein receiving the administrative request comprises receiving parameters associated with a protected resource to be used by the cloud-based application.

4. The method of claim 1, wherein the routing cryptography requests comprises one or more of:
receiving, by the HSM controller, a query from the cloud-based application for a mapping between the cloud-based application and the source VHSM so that the cloud-based application can interact directly with the source VHSM; and
serving, by the HSM controller, as a proxy for messages between the cloud-based application and the source VHSM over an encrypted tunnel.

5. The method of claim 1, wherein allocating comprises securing the source VHSM with initial authentication credentials, assigning the handle to the source VHSM, and returning the handle and the initial authentication credentials to the cloud-based application, and wherein the routing comprises:
receiving a customer request for a new key pair and certificate signing request (CSR) for certificate creation for an instance of the cloud-based application, the customer request including the handle for the source VHSM; and
using the handle to route the customer request to the source VHSM.

6. The method of claim 5, further comprising:
establishing a session between the cloud-based application and the source VHSM; and
subsequent to establishing the session, receiving, by the HSM controller from the cloud-based application, the customer request that the source VHSM is to one or more of generate the key pair and the CSR, obtain an associated certificate, load an existing key pair, and install certificates.

7. The method of claim 1, wherein the cloud-based HSM comprises a first HSM and wherein the method further comprises managing, by the HSM controller, the plurality of VHSMs to enable one or more of:
copying of one or more VHSMs of the plurality of VHSMs to a second cloud-based HSM;
deleting of one or more VHSMs of the plurality of VHSMs;
mapping of one or more VHSMs of the plurality of VHSMs to one or more cloud-based applications; and
ensuring that only authorized cloud-based applications can communicate with the VHSMs.

8. The method of claim 1, further comprising receiving, by the HSM controller, a management request, wherein the management request comprises a request to one or more of:
assign a target VHSM from among the plurality of VMSMs to a new instance of the cloud-based application, and copy the content of the source VHSM to the target VHSM; and
assign the target VHSM from among the plurality of VMSMs to the new instance of the cloud-based application, receive a file including protected resources from the cloud-based application, and store the file on the target VHSM.

9. The method of claim 8, wherein copying the content of the source VHSM to the target VHSM comprises:
instructing the target VHSM to generate an encryption key and output the encryption key;
instructing the source VHSM to encrypt the content of the source VHSM with the encryption key and return the encrypted contents; and
instructing the target VHSM to copy the encrypted contents and decrypt the contents with a private key of the target VHSM.

10. The method of claim 1, further comprising receiving, by the HSM controller, a management request comprising a request to modify a size of a VHSM in the set of VHSMs.

11. The method of claim 1, wherein each VHSM of the plurality of VHSMs supports an enable-copy function to prevent the copying of the VHSM without explicit authorization.

12. A controller configured to manage cloud-based hardware encryption module (HSM) services, comprises:
a transceiver;
a memory device;
a processor that is configured to:
receive, via the transceiver, an administrative request to enable a cloud-based application to have access to a cloud-based HSM service
segment a cloud-based HSM into a plurality of virtual HSMs (VHSMs);
allocate a source VHSM from the plurality of VHSMs to the cloud-based application, the source VHSM comprises at least one of an initial set of credentials, roles and metadata;
store, in the memory device, a handle for the source VHSM in association with a handle for the cloud-based application; and
route, via the transceiver, cryptography requests between the cloud-based application and the VHSM based on the handle for the source VHSM and the handle for the cloud-based application.

13. The controller of claim 12, wherein the processor is configured to secure cloud administrator functions with authentication credentials.

14. The controller of claim 12, wherein the administrative request includes parameters associated with a protected resource to be used by the cloud-based application.

15. The controller of claim 12, wherein the processor is configured to at least one of:
receive a query from the cloud-based application for a mapping between the cloud-based application and the source VHSM so that the cloud-based application can interact directly with the source VHSM; and
act as a proxy for messages between the cloud-based application and the source VHSM over an encrypted tunnel.

16. The controller of claim 12, wherein the processor is configured to allocate the source VHSM by securing the source VHSM with initial authentication credentials, assigning the handle to the source VHSM, and returning the handle and the initial authentication credentials to the cloud-based application, and wherein the processor is configured to route cryptography requests by:
receiving a customer request for a new key pair and certificate signing request (CSR) for certificate creation for an instance of the cloud-based application, the request including the handle for the source VHSM; and
using the handle to route the request to the source VHSM.

17. The controller of claim 16, wherein the processor is configured to:
establish a session between the cloud-based application and the source VHSM; and
subsequent to establishing the session, receive, from the cloud-based application and via the transceiver, the customer request that the source VHSM is to one or more of generate the key pair and the CSR, obtain an associated certificate, load an existing key pair, and install needed certificates.

18. The controller of claim 12, wherein the processor is configured to manage the set of VHSMs to enable one or more of:
modifying a size of a VHSM of the plurality of VHSMs;
copying of one or more VHSMs of the plurality of VHSMs to a second cloud-based HSM;
deleting of one or more VHSMs of the plurality of VHSMs;
mapping of one or more VHSMs to one or more cloud-based applications; and
ensuring that only authorized applications can communicate with the VHSMs.

19. The controller of claim 12, wherein the processor is configured to receive a management request via the transceiver, wherein the management request comprises a request to one or more of:
assign a target VHSM in the set of VMSMs to a new instance of the cloud-based application, and copy the content of the source VHSM to the target VHSM; and
assign the target VHSM in the set of VMSMs to the new instance of the application, receive a file including protected resources from the cloud-based application, and store the file on the target VHSM.

20. The controller of claim 19, wherein the processor is configured to copy the content of the source VHSM to the target VHSM by:
instructing the target VHSM to generate an encryption key pair and output the encryption key;
instructing the source VHSM to encrypt the content of the source VHSM with the encryption key and return the encrypted contents; and
instructing the target VHSM to copy the encrypted contents and decrypt the contents with a private key.
